(19) United States
(12) Patent Application Publication
(10) Pub. No.: US 2007/0262667 A1
(43) Pub. Date: Nov. 15, 2007

(54) Pneumatic powered electro-magnetic field generating device

(76) Inventor: Robert A. Charbonneau, Milltown, MT (US)

Correspondence Address: Liebler, Ivey, Connor & Berry & St. Hilaire;The Edison Professional Building, 1141 North Edison, Suite C, P.O. Box 6125, Kennewick, WA, 99336-0125, US

(21) Appl. No.: 11/208,919

(22) Filed: Aug. 22, 2005

Related U.S. Application Data
(60) Provisional application No. 60/604,121, filed on Aug. 23, 2004.

(51) Int. Cl. H02K 7/09

(52) U.S. Cl. 310/90.5

(57) ABSTRACT

An improved electro-magnetic field generating device, or field generator, which employs a high speed rotor, powered by compressed air, to generate a localized electro-magnetic field of high intensity. The field generator includes a hub that spins about a hub axis, and a charging ring that mounts to the hub that is centered on the hub axis. The charging ring receives an airstream from the hub. The airstream routes through the charging ring and back out into the hub. A housing formed from a metal material, encases the charging ring. A rotor mounts to the hub. The rotor is centered on the hub axis and receives the airstream from the hub. The airstream routes through the rotor to a pair of nozzles on the rotor am. The nozzles are oriented to exhaust the airstream at a tangent to the nozzle rotation, creating a rotational thrust to spin the charging ring. The generated field has potential uses in generating disruptive electro-magnetic fields and other potential effects, including the modification of efficiency and performance of engines and motors placed within the field, and in the emission characteristics of certain radioisotopes

This patent application is pending from provisional application No. 60/604,121 filed on Aug. 23, 2004.

### FIELD OF THE INVENTION

The invention relates to a method and apparatus for an electro-magnetic field generating device that employs a high speed rotor, powered by compressed air, to generate a localized electro-magnetic field of high intensity. The generated field has potential uses in generating disruptive electro-magnetic fields and other potential effects, including the modification of efficiency and performance of engines and motors placed within the field, and in the emission characteristics of certain radioisotopes.

### BACKGROUND OF THE INVENTION

The use of rotating metallic elements to generate electrical field effects is well known. Tesla, Holz, Teppler and Van de Graaf, all pioneered in developing devices to generate electro-magnetic field effects, such as: static electricity discharges, magnetic fields and electrical power generation.

The present invention improves upon a heretofore known device recently invented, which generates an electro-magnetic field. The fundamental elements of the present device, purportedly first introduced in the early 1990's, includes an air driven rotor that propels a circumferential ring, housed within a low pressure containment. The prior device had several limitations that kept it from realizing a full potential. These limitations are addressed in the present invention, with the improved device operating well beyond the expectations of the original, rudimentary and substantially experimental prototype.

### SUMMARY OF THE INVENTION

The present invention improves upon a heretofore known device recently invented, which generates an electro-magnetic field. The fundamental elements of the present device, purportedly first introduced in the early 1990's, includes an air driven rotor that propels a circumferential ring, housed within a low pressure containment. The prior device had several limitations that kept it from realizing a full potential. These limitations are addressed in the present invention, with the improved device operating well beyond the expectations of the original, rudimentary and substantially experimental prototype.

### BRIEF DESCRIPTION OF THE DRAWINGS

FIG. 1 is a sectioned side elevation view of an electro-magnetic field generating device, according to an embodiment of the invention;

FIG. 2 is a side elevation view of an electro-magnetic field generating device, according to an embodiment of the invention;

FIG. 3 is a side elevation view of an electro-magnetic field generating device, according to an embodiment of the invention;

FIG. 4 is a bottom view of an electro-magnetic field generating device, according to an embodiment of the invention;

FIG. 5 is a bottom perspective view of an electro-magnetic field generating device, according to an embodiment of the invention;

FIG. 6 is a perspective view of a portion of an electro-magnetic field generating device, according to an embodiment of the invention;

FIG. 7 is a sectioned side elevation view of a portion of an electro-magnetic field generating device, according to an embodiment of the invention;

FIG. 8A is a side elevation view of a portion of an electro-magnetic field generating device, according to an embodiment of the invention;

FIG. 8B is a side elevation view of a portion of an electro-magnetic field generating device, according to an embodiment of the invention;

FIG. 9 is a perspective view of a portion of an electro-magnetic field generating device, according to a embodiment of the invention;

FIG. 10 is a top view of a portion of an electro-magnetic field generating device, according to an embodiment of the invention;

FIG. 11 is a side view of a portion of an electro-magnetic field generating device, according to an embodiment of the invention;

FIG. 12 is a side view of a portion of an electro-magnetic field generating device, according to an embodiment of the invention;

FIG. 13 is a perspective view of a portion of an electro-magnetic field generating device, according to an embodiment of the invention;

FIG. 14 is a sectioned perspective view of a portion of an electro-magnetic field generating device, according to an embodiment of the invention;

FIG. 15 is a side view of a portion of an electro-magnetic field generating device, according to an embodiment of the invention;

FIG. 16 is a top view of a portion of an electro-magnetic field generating device, according to an embodiment of the invention;

FIG. 17 is a side view of a portion of an electro-magnetic field generating device, according to an embodiment of the invention; and

FIG. 18 is a side view of a portion of an electro-magnetic field generating device, according to an embodiment of the invention.

### DETAILED DESCRIPTION

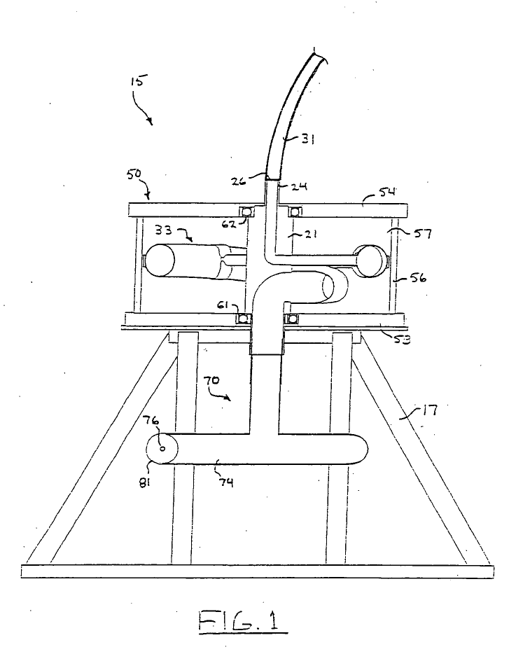

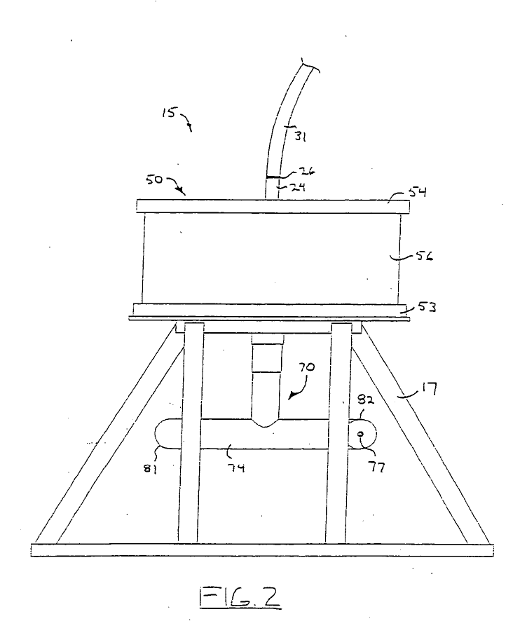

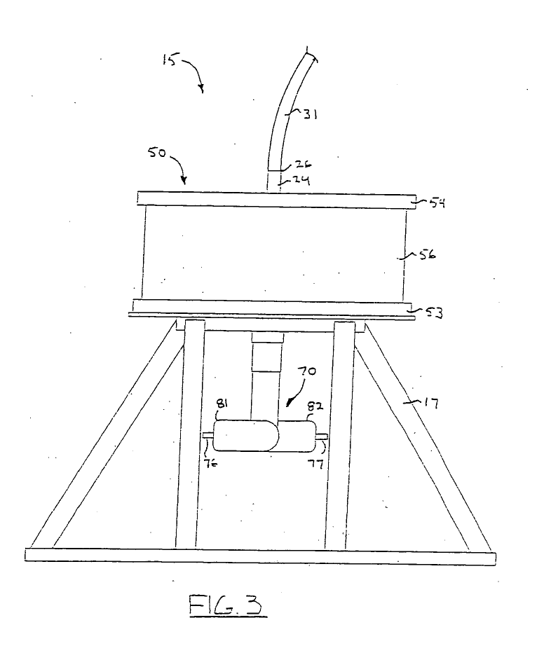

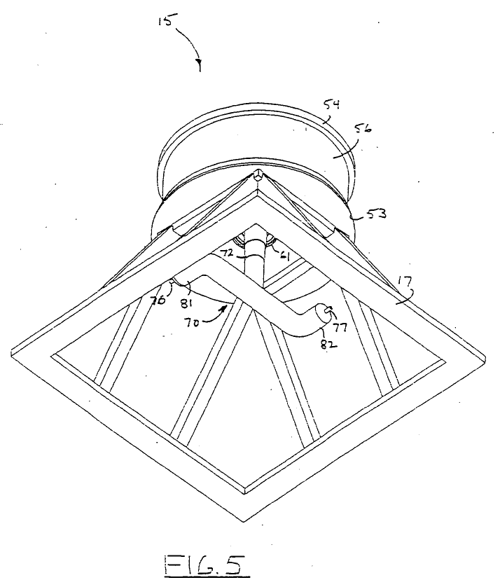

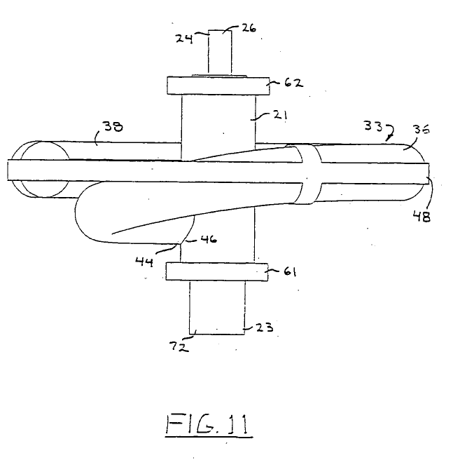

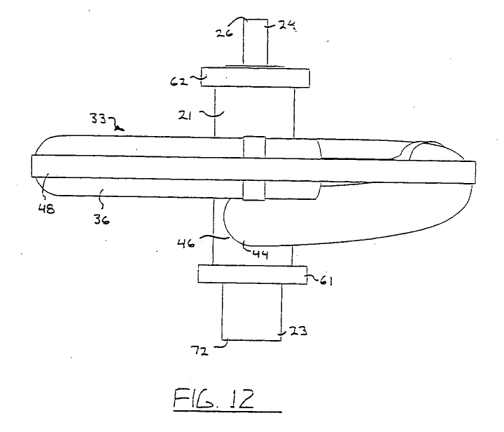

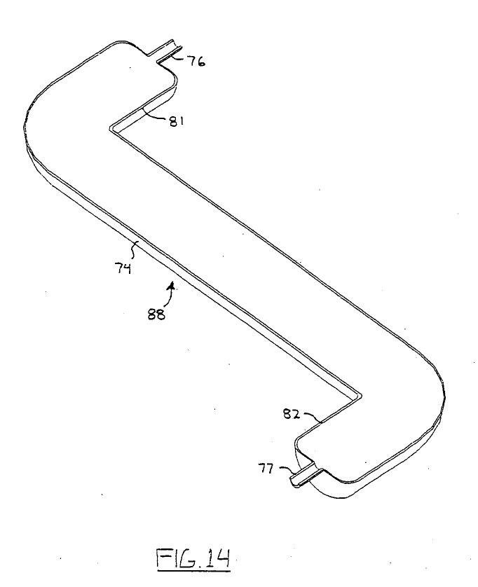

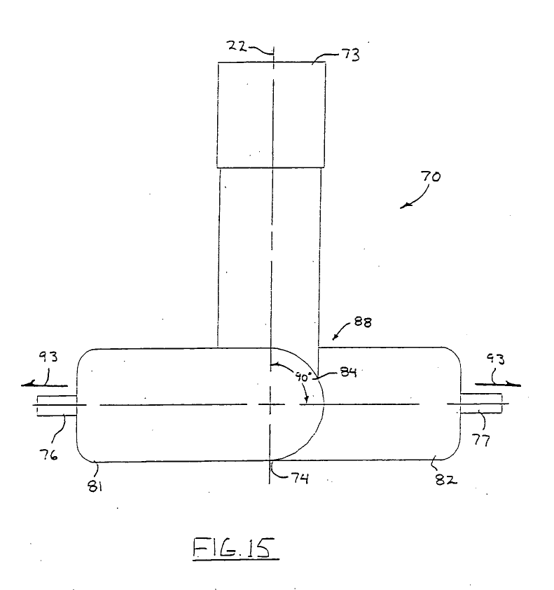

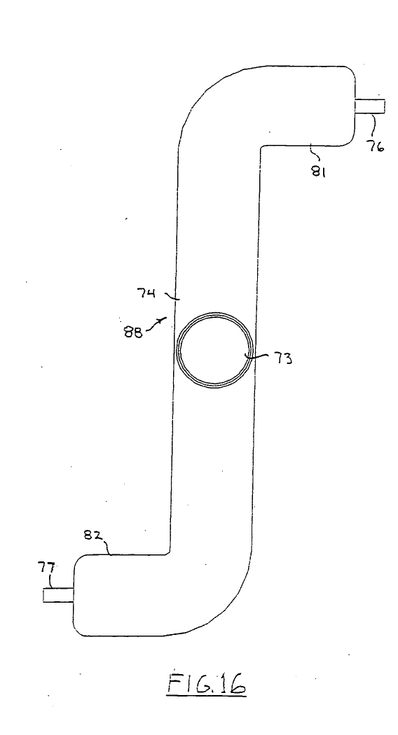

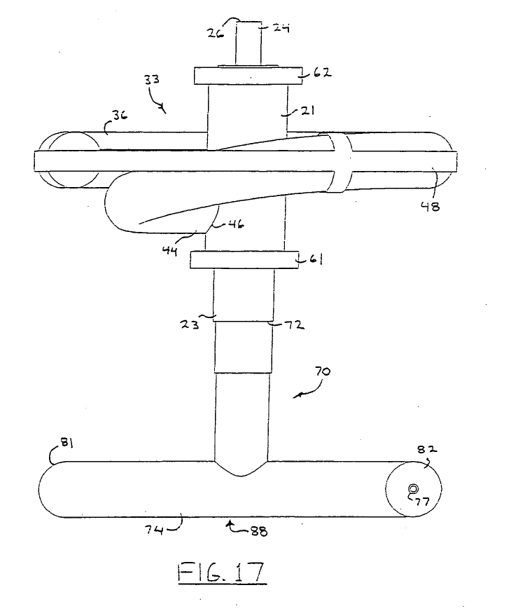

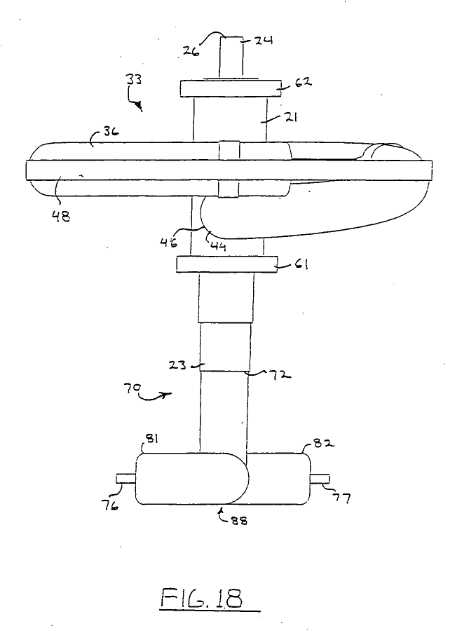

The invention provides improvements to a pneumatic powered device that generates a strong electro-magnetic field. Specifically, the device of the present invention employs a high speed rotor, powered by compressed air, to generate a localized electro-magnetic field of high intensity. The generated field has potential uses in the disruption of nearby elector-mechanical devices, and possibly in realizing improved efficiencies for engines and motors placed within the field. Additionally, the field generator has shown the ability to affect certain radioactive isotopes, as discussed later herein. A preferred embodiment of the electro-magnetic field generating device (15) is shown in FIGS. 1 through 18.

As detailed in FIGS. 1 through 5, the electro-magnetic field generating device (15), also referred to herein as the “field generator” is preferably mounted upon a stand (17). The field generator has a hub (21), with a hub axis (22) lengthwise within the hub, and central to the field generator. The hub rotates or “spins” around the hub axis. Preferably, the hub axis is oriented vertically, and so the field generator has a first end (23) and a second end (24), and is substantially symmetrical about the hub axis. For this preferred embodiment of the field generator, the first end is referred to herein as the “bottom,” or proximate to the bottom of the device, and the second end is referred to herein as the “top,” or proximate to the top of the device.

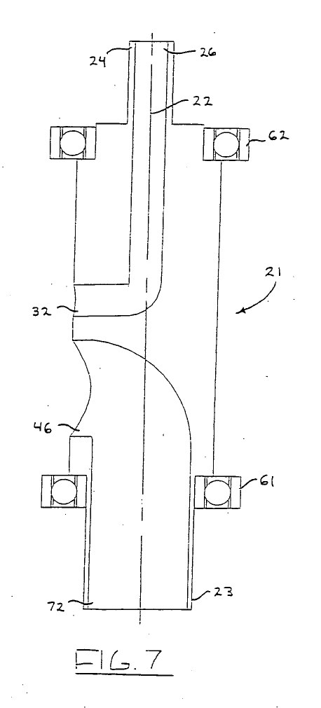

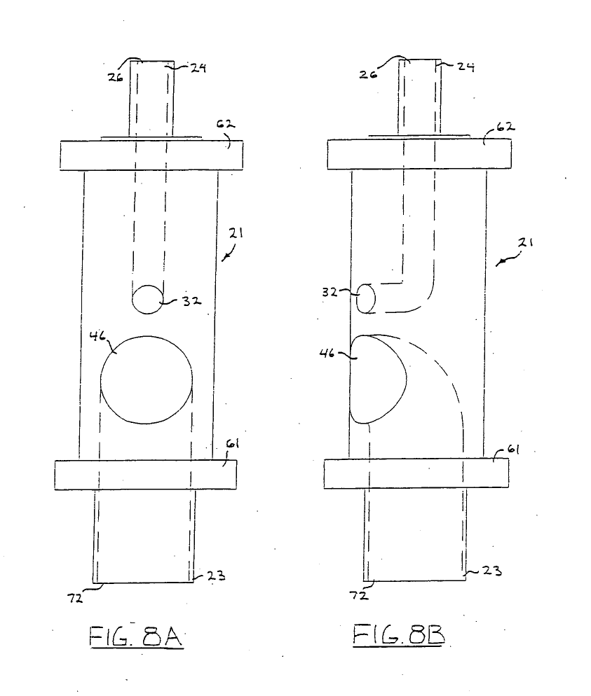

The hub (21), as detailed in FIGS. 7, 8A and 8B, is preferably manufactured from a metal material having a high tensile strength. Alternatively, a high strength plastic material is envisioned as a potential alternative. Most preferably, the hub is milled from “3O4” type stainless steel. The hub includes a hub inlet (26), the hub inlet is positioned proximate to the first end (23), or preferably the top of the field generator (15). The hub inlet receives an airstream (30), which is under a high pressure, most preferably approximately 210 psi. The term “approximately” is employed herein throughout this detailed description and claims, with the understanding that is denotes a level of exactitude commensurate with the skill and precision typical for the particular field of endeavor, as applicable.

The range of preferred pressure for the airstream (30) can be varied to the operational need of the field generator and its specific design constraints. Preferred operational pressures of the airstream delivered to the inlet hub can easily range from approximately 185to 250 psi. The airstream is preferably supplied from a compressor through a high pressure reinforced hose (31), which attaches to the hub inlet with a threaded connection. At operational pressure, approximately 360 scfm (standard cubic feet per minute) to 400 scfm of airstream flows through this preferred embodiment of the field generator.

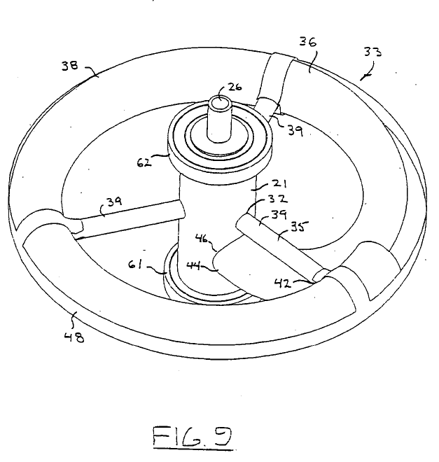

The hub (21) also includes a hub ring outlet (32), as shown in FIG. 7. The hub ring outlet is positioned along the hub and serves to route the airstream out of the hub to a charging ring (33), as shown in FIGS. 9 through 12, preferably through a radius air pipe (35) to a ring pipe (36) of the charging ring. The charging ring is formed from a metallic material (38) and most preferably “3O4” type stainless steel, just as the hub. The charging ring mounts to the hub, with the charging ring centered on the hub axis (22). Preferably, a plurality of radial supports (39) or “spokes” are employed to provide a strong and vibration free connection between the hub and the ring pipe of the charging ring. One of the spokes preferably serves as the radius air pipe, to route the airstream from the hub to the ring pipe.

As shown in FIG. 1, a ring chamber (41) is enclosed within the ring pipe (36) of the charging ring (33). The ring chamber receives the airstream from the radius air pipe through a ring inlet (42). The radius air pipe connects the hub ring outlet (32) to the ring inlet. The airstream is then able to route through the ring pipe, around the circumference of the charging ring, to a ring outlet (44). The ring outlet is connected to a hub ring inlet (46) on the hub (21).

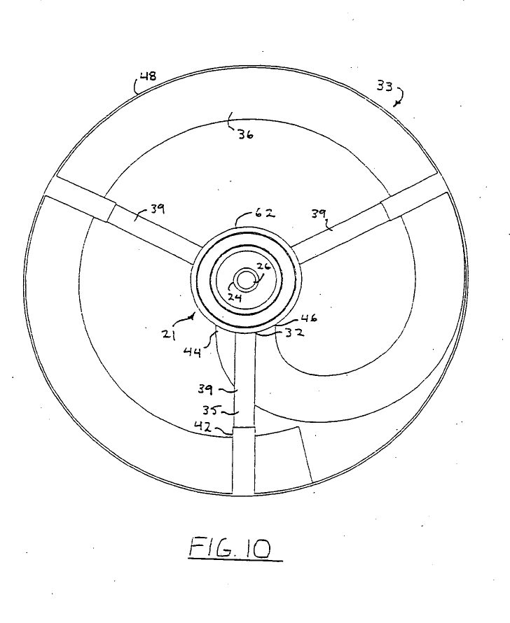

The ring pipe (36) most preferably curves in transition from the circumference of the charging ring (33) to the hub ring inlet (32) as shown in FIGS. 1 and 10. The smooth transition of the airstream (30) from the charging ring is important to aid in minimizing turbulence and air hammer as the airstream exits the charging ring, against the rotation of the charging ring. The charging ring is most preferably, approximately three inches in diameter, for this preferred embodiment of the field generator (15).

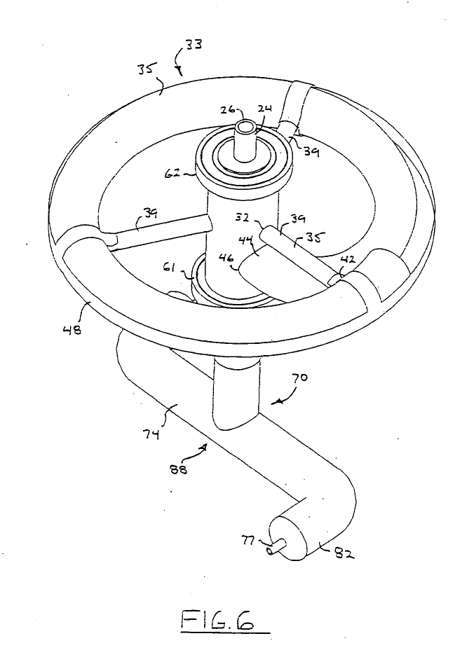

The charging ring (33) is also bounded by a hoop (48), as shown in FIGS. 6, 9, 10, 11 and 12. The hoop is preferably formed of a strong, metallic material, which in the preferred embodiment is the same metallic material (38) as the ring pipe (36), to bind the ring pipe to a circle, providing for a balanced. rotation of the charging ring.

A housing (50) encases the charging ring (33) as shown in FIG. 1. The housing is preferably formed from a metallic housing material (51). As an alternative, the housing can be grounded to reduce static discharge from the field generator (15) during operation. The housing includes a first plate (53), near the fist or bottom end (23) of the field generator, and a second plate (54), near the second or top end (24) of the field generator. For the present embodiment, the first plate can also be referred to as the bottom plate, or as preferred, the base plate, and is capped by the top plate, as shown in FIGS. 1, 2, and 3.

The base plate (53), the sidewall (56) and the top plate (54) define the housing (50), and encase a housing enclosure (57), within. The housing enclosure contains the charging ring (33). Therefore the sidewall is preferably cylindrical in shape, capped above and below by the top plate and bottom plate respectively. As an alternative to the preferred embodiment, to aid in the operation of the field generator (15), the housing enclosure may be substantially evacuated of atmosphere. By maintaining the housing enclosure at a low pressure (58), relative to a standard atmospheric pressure (59), a rotational resistance of the charging ring can be reduced as it spins about the hub axis (22), if needed.

The metallic housing material (51) for the housing (50), including the base plate (53), top plate (54), and the sidewall (56) are all preferably fabricated from a wrought aluminum allow. Specifically a high strength allow, such as tempered “6061T651” aluminum is more preferred for its strength, corrosion resistence and formability.

In an alternative embodiment of the field generator (15) of the present invention, the housing enclosure (57) can be maintained at a vacuum of 2 psi to 5 psi, absolute or “psia.” This evacuation of the housing enclosure serves to minimize air resistance to the charging ring (33), as it spins. If the housing (50) is well sealed, a small pump can be used to evacuate the housing and maintain it under negative pressure, relative to the atmosphere, which is considered 14.7 psia (at sea level), as the standard atmospheric pressure.

To allow the charging ring (33) to spin within the hub (21), a first bearing (61) mounts to the first or base plate (53) of the housing, and a second bearing (62) mounts to the second plate of the housing, as shown in FIG. 1. Again, since the first end of the field generator is the bottom for this preferred embodiment, the first bearing is also referred to as the bottom bearing herein. Likewise, since the second end of the field generator is the top for this preferred embodiment, the second bearing is also referred to as the top bearing. The bottom bearing and the top bearing are preferably high velocity bearings. Most preferably, Fafnir® ABEC-7, counterbored 20 mm bore duplex universal precision bearings, specifically model “2MM220WIDUL,” as manufactured by Timken Company, of Canton Ohio, USA, are employed.

As an alternative to the preferred embodiment of the present invention, the base bearing (61), which receives the hub (21), can provide a base seal (63) between the low pressure (58) within the housing enclosure (57) and the standard atmospheric pressure (59) external to the housing (50). The top bearing (62) also receives the hub (21), and can provide a top seal (64) between the low pressure within the housing enclosure and the standard atmospheric pressure external to the housing.

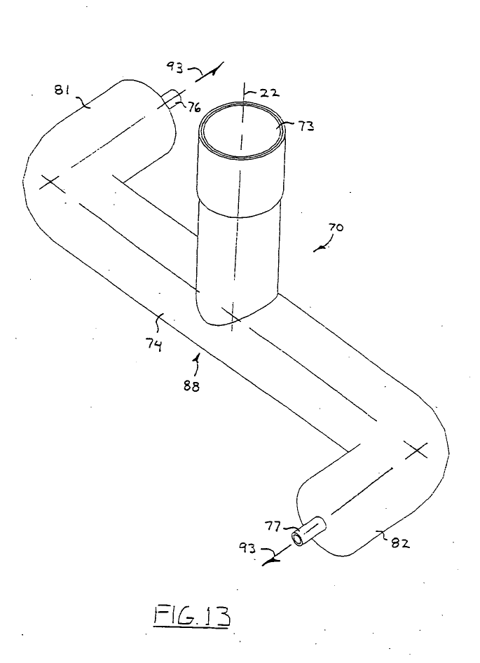

As discussed above, the airstream (30) leaves the ring pipe (36) of the charging ring (33) through the ring outlet (44) to the hub ring inlet (46) on the hub (21). The airstream then exits the housing (50), past the base seal (63), to a rotor (70), which is mounted to the hub. The rotor is centered on the hub axis (22), as shown in FIG. 13, and preferably attached by a threaded connection. Specifically, the airstream exits the hub through a hub rotor outlet (72), proximate to the bottom end (23) of the field generator, and enters the rotor through a rotor inlet (73). Like the charging ring, the rotor is also preferably formed from a pipe of approximately three inches in diameter. The rotor is most preferably formed from a heat fuseable, thick walled, poly ethylene pipe material. The joints may be threaded or glued, but are preferable heat fused or welded, to provide a strong and permanent connection.

The rotor (70) has a rotor arm (74), with a first nozzle (76) and a second nozzle (77), as shown in FIGS. 13 through 16. The rotor is symmetrical about the hub axis (22), with the first nozzle and the second nozzle separated at an equal distance by the rotor arm. As shown in FIG. Y, the first nozzle mounts to a first arm end (81) of the rotor arm, and the second nozzle mounts to a second arm end (82) of the rotor arm, opposite the first nozzle. The first nozzle and the second nozzle have an optimal nozzle opening diameter of nozzle size ⅜″. However, any approximate nozzle opening diameter may be utilized that provides for a sufficient quantity of the airstream (30) to escape, while providing adequate thrust to rotate the rotor about the hub axis.

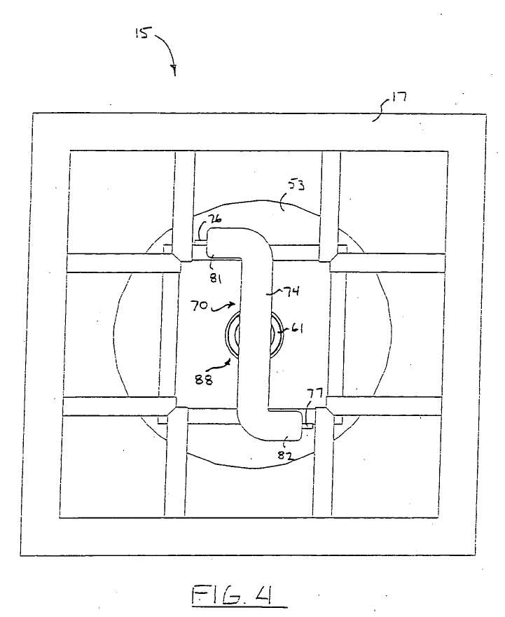

As shown in FIGS. 4 and 13 the rotor arm (74) extends from the hub (21) at a right angle (84) to the hub axis (22). The “right” angle is approximately 90 degrees to the hub axis. Prior prototypes of the present invention failed to include a balanced rotator configuration. The inventors of the present field generator found that operational vibrations and inefficiencies resulted from a single nozzle mounted on a simple rotor. As rotational velocity increased, the simple rotor became unstable and rotational spin was governed or constrained to a lower rate, as compared to the exceptional spin rate of the present invention.

The first nozzle (76) and the second nozzle (77), as attached to the first arm end (81) and the second arm (82) respectively, rotate about the hub (21) in a nozzle rotation (86), shown as a rotational center line in FIG. 4. Upon entering the rotor (70), the airstream (30) routes through the rotor arm (74), and is split between the first nozzle and the second nozzle at a “Tee” (88). The first nozzle and the second nozzle are optimally oriented to exhaust the airstream at a tangent (92) to the nozzle rotation, which for the preferred embodiment shown in FIG. 13, is a “right” or 90 degree angle to the rotor arm, and also at the right angle (84) to the hub axis (22). This orientation of the nozzles create a rotational thrust (93) that spins the charging ring (33) at a high rate of speed. An optimal “charging” by the hub, charging ring, and rotor of the field generator (15) in this preferred embodiment occurs at 725 revolutions per minute (RPM), with 640 RPM through 750 RPM considered acceptable.

### Example 1

A small sample of a radioactive isotope material, “Americium 241” was wrapped in a first photographic film. The film was examined after approximately six hours. The first photographic film had discolored, as expected, and attributable to radioactive emissions from the Americium sample. The radioactive material was then wrapped in a second photographic film and placed near the field generator (15), while the field generator was operated, as discussed herein above. The field generator was operated for approximately the same time period as the “check” first photographic film. Remarkably, as verified by a professional laboratory film developing technician, the second photographic film lacked any observable induced discoloration, as was observed in the first photographic film.

### Example 2

A laboratory electro magnetic measuring device, specifically, a PASCO® model SE-9638 e/m apparatus, as manufactured by PASCO Scientific of Roseville Calif., USA, was employed to visually ascertain the electro-magnetic field of the field generator (15). The SE-9638 showed a perturbation in the normal circular electron trail within its helium filled vacuum tube. When the field generator was operated, a pronounced circular “ghost” of the electron trail appeared within the tube of the SE-9638, concentric to the primary “normal” electron trail.

In compliance with the statutes, the invention has been described in language more or less specific as to structural features and process steps. While this invention is susceptible to embodiment in different forms, the specification illustrates preferred embodiments of the invention with the understanding that the present disclosure is to be considered an exemplification of the principles of the invention, and the disclosure is not intended to limit the invention to the particular embodiments described. Those with ordinary skill in the art will appreciate that other embodiments and variations of the invention are possible, which employ the same inventive concepts as described above. Therefore, the invention is not to be limited except by the following claims, as appropriately interpreted in accordance with the doctrine of equivalents.

I claim:

1. An apparatus generating a strong electro-magnetic field comprising:
a. a field generator, powered by rotating power means, generating a localized electro-magnetic field of high intensity.

2. An apparatus depending from claim 1 further comprising:
a. the field generator (15), is mounted upon a mounting means (17) including a stand (17);
b. the field generator has a hub (21), with a hub axis (22) lengthwise within the hub, and central to the field generator (15); the hub (21) rotates or “spins” around the hub axis (22); the hub axis (22) is oriented vertically; the field generator (15) has a first end (23) or “bottom” and is proximal a bottom of the device and a second end (24) or “top” which is proximal a top of the device, and is substantially symmetrical about the hub axis (22);
c. the hub (21) is preferably manufactured from a material having a high tensil strength means or a high strength means including a metal material having a high tensile strength or a high strength plastic material; the high tensil strength means material includes “3O4” type stainless steel
d. the hub (21) includes a hub inlet (26), the hub inlet is positioned proximate to the first end (23), or preferably the top of the field generator (15); the hub inlet receives an airstream (30), which is under a high pressure; high pressure may be approximately 210 psi, however, a range of preferred pressure for the airstream (30) can be varied to the operational need of the field generator and its specific design constraints and may be in a range from approximately 185 to 250 psi;
e. the airstream is preferably supplied from a compressor through a high pressure reinforced hose (31), which attaches to the hub inlet with a connection means including a threaded connection; at operational pressure, approximately 360 scfm (standard cubic feet per minute) to 400 scfm of airstream flows through this preferred embodiment of the field generator;
f. the hub (21) also includes a hub ring outlet (32) which is positioned along the hub and serves to route the airstream out of the hub to a charging ring (33) preferably through a radius air pipe (35) to a ring pipe (36) of the charging ring; the charging ring is formed from a metallic material (38) and most preferably “304” type stainless steel and mounts to the hub, with the charging ring centered on the hub axis (22); at least one or a plurality of radial supports (39) or “spokes” are employed to provide a strong and vibration free connection between the hub and the ring pipe of the charging ring; at least one of the spokes preferably serves as the radius air pipe, to route the airstream from the hub to the ring pipe;
g. a ring chamber (41) is enclosed within the ring pipe (36) of the charging ring (33); the ring chamber receives the airstream from the radius air pipe through a ring inlet (42); the radius air pipe connects the hub ring outlet (32) to the ring inlet; the airstream is then able to route through the ring pipe, around the circumference of the charging ring, to a ring outlet (44); the ring outlet is connected to a hub ring inlet (46) on the hub (21);
h. the ring pipe (36) most preferably curves in transition from the circumference of the charging ring (33) to the hub ring inlet (32); the smooth transition of the airstream (30) from the charging ring is important to aid in minimizing turbulence and air hammer as the airstream exits the charging ring, against the rotation of the charging ring; the charging ring is most preferably, approximately three inches in diameter, for this preferred embodiment of the field generator (15);
i. the charging ring (33) is also bounded by a hoop (48) and the hoop is preferably formed of a strong, metallic material, which in the preferred embodiment is the same metallic material (38) as the ring pipe (36), to bind the ring pipe to a circle, providing for a balanced. rotation of the charging ring;
j. a housing (50) encases the charging ring (33); the housing is preferably formed from a metallic housing material (51) and the housing can be grounded to reduce static discharge from the field generator (15) during operation; the housing includes a first plate (53), near the fist or bottom end (23) of the field generator, and a second plate (54), near the second or top end (24) of the field generator; and the first plate can also be referred to as the bottom plate, or the base plate, and is capped by the top plate;
k. The base plate (53), the sidewall (56) and the top plate (54) define the housing (50), and encase a housing enclosure (57), within; the housing enclosure contains the charging ring (33); therefore the sidewall is preferably cylindrical in shape, capped above and below by the top plate and bottom plate respectively or, as an alternative to the preferred embodiment, to aid in the operation of the field generator (15), the housing enclosure may be substantially evacuated of atmosphere;
l. by maintaining the housing enclosure at a low pressure (58), relative to a standard atmospheric pressure (59), a rotational resistance of the charging ring can be reduced as it spins about the hub axis (22), the metallic housing material (51) for the housing (50), including the base plate (53), top plate (54), and the sidewall (56) are all preferably fabricated from a wrought aluminum alloy including a high strength allow, such as tempered “6061T651” aluminum which is preferred for its strength, corrosion resistence and formability.

3. An apparatus depending from claim 2 further comprising:
a. the field generator (15), the housing enclosure (57) can be maintained at a vacuum of 2 psi to 5 psi, absolute or “psia” minimizing air resistance to the charging ring (33), as it spins; where the housing (50) is well sealed, a small pump can be used to evacuate the housing and maintain it under negative pressure, relative to the atmosphere, which is considered 14.7 psia (at sea level), as the standard atmospheric pressure;
b. to allow the charging ring (33) to spin within the hub (21), a first bearing (61) mounts to the first or base plate (53) of the housing, and a second bearing (62) mounts to the second plate of the housing; since the first end of the field generator is the bottom for this preferred embodiment, the first bearing is also referred to as the bottom bearing; since the second end of the field generator is the top for this preferred embodiment, the second bearing is also referred to as the top bearing; the bottom bearing and the top bearing are preferably high velocity bearings and most preferably, Fafnir® ABEC-7, counterbored 20 mm bore duplex universal precision bearings, specifically model “2MM220WIDUL,” as manufactured by Timken Company, of Canton Ohio, USA;

4. An apparatus depending from claim 3 further comprising:
a. the base bearing (61), which receives the hub (21), can provide a base seal (63) between the low pressure (58) within the housing enclosure (57) and the standard atmospheric pressure (59) external to the housing (50); the top bearing (62) also receives the hub (21), and can provide a top seal (64) between the low pressure within the housing enclosure and the standard atmospheric pressure external to the housing;
b. the airstream (30) leaves the ring pipe (36) of the charging ring (33) through the ring outlet (44) to the hub ring inlet (46) on the hub (21); the airstream then exits the housing (50), past the base seal (63), to a rotor (70), which is mounted to the hub; the rotor is centered on the hub axis (22)and preferably attached by a threaded connection; the airstream exits the hub through a hub rotor outlet (72), proximate to the bottom end (23) of the field generator, and enters the rotor through a rotor inlet (73); like the charging ring, the rotor is also preferably formed from a pipe of approximately three inches in diameter; the rotor is most preferably formed from a heat fuseable, thick walled, poly ethylene pipe material; the joints may be threaded or glued, but are preferable heat fused or welded, to provide a strong and permanent connection;
c. the rotor (70) has a rotor arm (74), with a first nozzle (76) and a second nozzle (77); the rotor is symmetrical about the hub axis (22), with the first nozzle and the second nozzle separated at an equal distance by the rotor arm; the first nozzle mounts to a first arm end (81) of the rotor arm, and the second nozzle mounts to a second arm end (82) of the rotor arm, opposite the first nozzle; the first nozzle and the second nozzle have an optimal nozzle opening diameter of nozzle size ⅜″; however, any approximate nozzle opening diameter may be utilized that provides for a sufficient quantity of the airstream (30) to escape, while providing adequate thrust to rotate the rotor about the hub axis;
d. the rotor arm (74) extends from the hub (21) at a right angle (84) to the hub axis (22); the “right” angle is approximately 90 degrees to the hub axis;
e. the first nozzle (76) and the second nozzle (77), as attached to the first arm end (81) and the second arm (82) respectively, rotate about the hub (21) in a nozzle rotation (86), shown as a rotational center line; upon entering the rotor (70), the airstream (30) routes through the rotor arm (74), and is split between the first nozzle and the second nozzle at a “Tee” (88); the first nozzle and the second nozzle are optimally oriented to exhaust the airstream at a tangent (92) to the nozzle rotation, which for the preferred embodiment, is a “right” or 90 degree angle to the rotor arm, and also at the right angle (84) to the hub axis (22); this orientation of the nozzles create a rotational thrust (93) that spins the charging ring (33) at a high rate of speed; an optimal “charging” by the hub, charging ring, and rotor of the field generator (15) in this preferred embodiment occurs at 725 revolutions per minute (RPM), with 640 RPM through 750 RPM considered acceptable.
